(19) United States
(12) Patent Application Publication
(10) Pub. No.: US 2022/0347924 A1
(43) Pub. Date: Nov. 3, 2022

(54) BIOFABRICATION SYSTEMS WITH BIOSAFETY CABINETS AND METHODS FOR USING THE SAME

(71) Applicant: Advanced Solutions Life Sciences, LLC, Louisville, KY (US)

(72) Inventors: Michael Golway, Louisville, KY (US); Justin Palmer, Louisville, KY (US); Scott Cambron, Louisville, KY (US)

(73) Assignee: Advanced Solutions Life Sciences, LLC, Louisville, KY (US)

(21) Appl. No.: 17/731,951

(22) Filed: Apr. 28, 2022

Related U.S. Application Data
(60) Provisional application No. 63/181,040, filed on Apr. 28, 2021.

(51) Int. Cl. B29C 64/364; B25J 21/00; B33Y 30/00; B08B 15/02

(52) U.S. Cl. CPC B29C 64/364; B25J 21/00; B33Y 30/00; B08B 15/02

(57) ABSTRACT

A biofabrication system includes a workstation and an articulating arm disposed within a work area of a biosafety cabinet. The workstation includes a stage for biofabrication. The biosafety cabinet includes an integration port that provides access to the work area through a wall of the biosafety cabinet. The articulating arm may be positioned to reach the workstation and the integration port.

### CROSS REFERENCE TO RELATED APPLICATION

This application claims priority to U.S. Provisional Application Ser. No. 63/181,040 filed on Apr. 28, 2021, the entire disclosure of which is hereby incorporated by reference.

### TECHNICAL FIELD

The present specification generally relates to the field of sterile biofabrication.

### BACKGROUND

Biofabrication is becoming more common in the additive manufacturing fields and readily available within the life sciences, medical, and pharmaceutical research fields, in both academic and commercial sectors.

Some current bioprinting platforms for biofabrication may contain filtration systems. However, these filtration systems often do not guarantee sterility and laminar flow within the workspace. This is especially true if the doors to such a filtered workspace are opened for a period of time. Moreover, these platforms and filtration systems often rely on human action as the biofabrication product is moved through the workflow, e.g. from one station to another. This human action, or human intervention, increases the likelihood of contamination to the biofabrication product.

### SUMMARY

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

In a first aspect A1, a biofabrication system includes a biosafety cabinet, a workstation, and an articulating arm. The biosafety cabinet includes an integration port that provides access to a work area within the biosafety cabinet through a wall of the biosafety cabinet. The workstation is disposed within the work area of the biosafety cabinet and includes a stage configured for biofabrication. The articulating arm is disposed within the work area of the biosafety cabinet and is positioned to reach the workstation and the integration port.

In a second aspect A2 according to the first aspect A1, the integration port is positioned at a back wall of the biosafety cabinet.

In a third aspect A3 according to any preceding aspect, the biosafety cabinet maintains a positive pressure at the integration port such that air may pass out the biosafety cabinet through the integration port but is prevented from passing into the biosafety cabinet through the integration port.

In a fourth aspect A4 according to any preceding aspect, the biosafety cabinet further includes a cabling panel through a back wall of the biosafety cabinet.

In a fifth aspect A5 according to any preceding aspect, the biofabrication system further includes a conveyer positioned to extend into the biosafety cabinet through the integration port.

In a sixth aspect A6 according to any preceding aspect, the biofabrication system further includes a second articulating arm disposed outside of the biosafety cabinet and configured to pass an item into the biosafety cabinet via the integration port.

In a seventh aspect A7 according to the sixth aspect A6, the biofabrication system further includes a second station, wherein the second articulating arm is configured to pass the item from the second station and into the biosafety cabinet via the integration port.

In an eighth aspect A8 according to any preceding aspect, the biosafety cabinet includes a sash and defines an opening into the biosafety cabinet beneath the sash.

In a ninth aspect A9 according to any preceding aspect, the workstation is coupled to the biosafety cabinet such that the workstation may be tilted upward.

In a tenth aspect A10 according to any preceding aspect, the biosafety cabinet is supported by legs having adjustable height.

In an eleventh aspect A11 according to any preceding aspect, the workstation includes an end effector bay.

In a twelfth aspect A12 according to any preceding aspect, the workstation includes a temperature sensor configured and positioned to measure an air temperature within the work area.

In a thirteenth aspect A13, a method of biofabrication includes printing a bioproduct on a stage of a biofabrication system. The biofabrication system includes a biosafety cabinet, a workstation, and an articulating arm. The biosafety cabinet includes an integration port that provides access to a work area within the biosafety cabinet through a wall of the biosafety cabinet. The workstation is disposed within the work area of the biosafety cabinet and includes a stage configured for biofabrication. The articulating arm is disposed within the work area of the biosafety cabinet and is positioned to reach the workstation and the integration port.

In a fourteenth aspect A14 according to the thirteenth aspect A13, the method further includes maintaining a positive pressure at the integration port such that air may pass out the biosafety cabinet through the integration port but is prevented from passing into the biosafety cabinet through the integration port.

In a fifteenth aspect A15 according to the thirteenth aspect A13 or the fourteenth aspect A14, the method further includes transferring the bioproduct out of the biosafety cabinet using the articulating arm.

In a sixteenth aspect A6 according to the fifteenth aspect A15, the transferring the bioproduct includes positioning the bioproduct on a conveyer using the articulating arm, wherein the conveyer extends through the integration port.

In a seventeenth aspect A17 according to the sixteenth aspect A16, the method further includes transferring the bioproduct to a second station using a second articulating arm.

In an eighteenth aspect A18, a method of biofabrication includes receiving an item through an integration port of a biofabrication system and moving the item from the integration port to a workstation with an articulating arm. The biofabrication system includes the integration port, the workstation, and the articulating arm. The integration port provides access to a work area within the biosafety cabinet through a wall of the biosafety cabinet. The workstation is disposed within the work area of the biosafety cabinet and includes a stage configured for biofabrication. The articulating arm is disposed within the work area of the biosafety cabinet and is positioned to reach the workstation and the integration port.

In a nineteenth aspect A19 according to the eighteenth aspect A18, the method further includes maintaining a positive pressure at the integration port such that air may pass out the biosafety cabinet through the integration port but is prevented from passing into the biosafety cabinet through the integration port.

In a twentieth aspect A20 according to the eighteenth aspect A18 or the nineteenth aspect A19, the receiving the item through the integration port includes transporting the item on a conveyer extending through the integration port.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a front prospective view of a platform including a biosafety cabinet for biofabrication, according to one or more embodiments shown and described herein;

FIG. 2 schematically depicts a front view of a work area of the biosafety cabinet of FIG. 1, according to one or more embodiments shown and described herein;

FIG. 3 schematically depicts a front view of another biosafety cabinet, according to one or more embodiments shown and described herein;

FIG. 4 schematically depicts a rear view of a back wall of the biosafety cabinet of FIG. 1, according to one or more embodiments shown and described herein;

FIG. 5 schematically depicts a side view of a biofabrication system including the platform and biosafety cabinet of FIG. 1; and

FIG. 6 schematically depicts a front view of the work area of FIG. 2.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### DETAILED DESCRIPTION

Reference will now be made in detail to various embodiments of devices, assemblies, and methods, examples of which are illustrated in the accompanying drawings. Whenever possible, the same reference numerals will be used throughout the drawings to refer to the same or like parts. The present disclosure generally relates to a biofabrication system that includes a workstation and an articulating arm disposed within a work area of a biosafety cabinet. The workstation may include a stage for biofabrication. The biosafety cabinet may include an integration port that provides access to the work area through a wall of the biosafety cabinet. The articulating arm may be positioned to reach the workstation and the integration port. In this way, the articulating arm may receive or send out an item, such as a bioproduct, through the integration port and may move the item about the workstation without sacrificing the laminar flow or sterile environment of the biosafety cabinet. In some embodiments, the laminar flow and sterile environment may be maintained within the work area of the biosafety cabinet even when the integration port remains fully open.

Directional terms as used herein—for example up, down, right, left, front, back, top, bottom—are made only with reference to the figures as drawn and are not intended to imply absolute orientation unless otherwise specified.

The term “biofabrication” is used herein to refer generally to the processes of bioprinting, biomanufacturing, bioassembly, and the like. As used herein, biofabrication may include automated and partially automated processes that generate or assist in generating products made from living cells, bioactive molecules, biomaterials, and the like.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any device or assembly claim does not actually recite an order or orientation to individual components, or it is not otherwise specifically stated in the claims or description that the steps are to be limited to a specific order, or that a specific order or orientation to components of an device or assembly is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an,” and “the” include plural referents unless the context clearly dictates otherwise. Thus, for example, reference to “a” component includes aspects having two or more such components, unless the context clearly indicates otherwise.

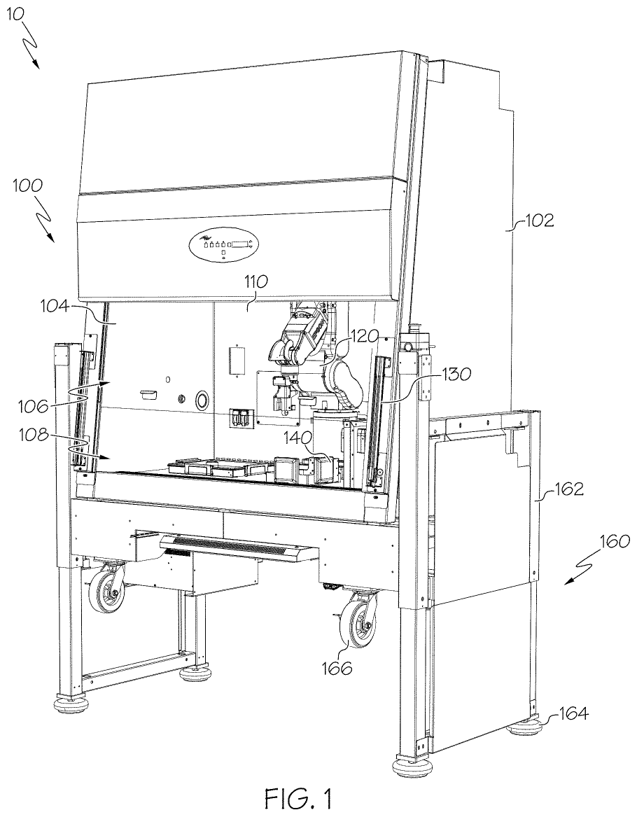

FIG. 1 schematically depicts a platform 10. As shown, the platform 10 may include a plurality of subassemblies. For example, the platform 10 may include a biosafety cabinet 100, an articulating arm 120, a workstation 140, and a machine base 160. In embodiments, the size of the biosafety cabinet 100 may vary, depending on the needs of the user. In embodiments, the biosafety cabinet 100 may range from about 3 feet, about 4 feet, about 5 feet, about 6 feet, or larger in width. In some embodiments, the biosafety cabinet 100 may be a Class II, Type A or B biosafety cabinet. In some embodiments, the biosafety cabinet 100 may be custom designed to fit the requirements of a particular application.

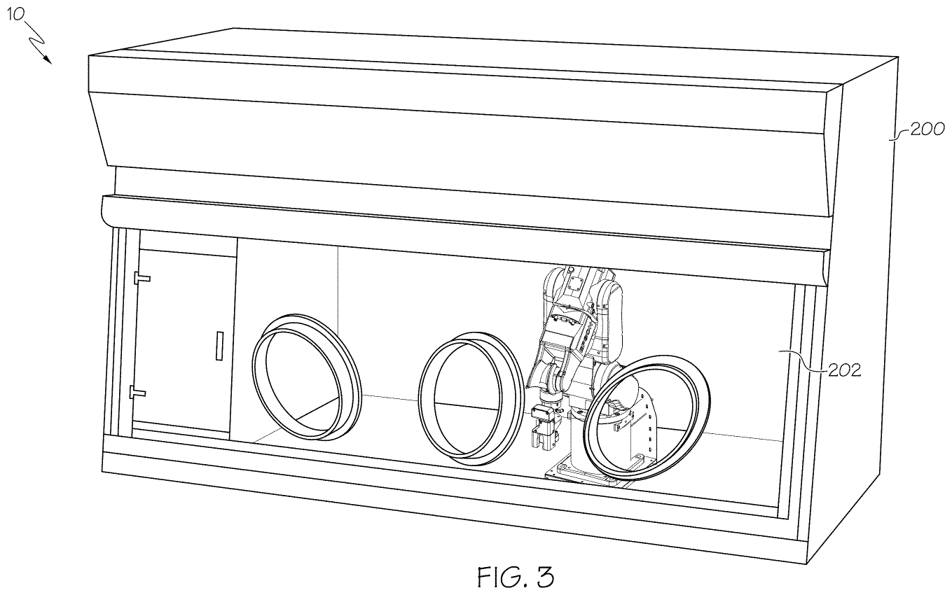

Referring to FIG. 1, the biosafety cabinet 100 may include a body 102 that defines a work area 106 within the body 102. The biosafety cabinet 100 may include a sash 104 coupled to the body 102. The sash 104 may be substantially clear such that an operator may see through the sash 104 and into the work area 106. The sash 104 may be coupled to the body 102 such that it defines an opening 108 beneath the sash 104. In some embodiments, the sash 104 may be moveable up and down to adjust the size of the opening 108. The opening 108 may allow an operator positioned outside of the biosafety cabinet 100 to access to the works area 106 of the biosafety cabinet 100. Referring briefly to FIG. 3, in some embodiments, the platform 10 may include a biosafety cabinet 200 that may be a pharmaceutical grade biosafety cabinet. Accordingly, the biosafety cabinet 200 may have side port vestibule access (not depicted) and a glovebox front sash 202 for human intervention, rather than the sash 104 as depicted in FIG. 1. Referring to FIGS. 1 and 3 in combination, as will be appreciated by those skilled in the art, the platform 10 may include either the biosafety cabinet 100 or the biosafety cabinet 200 or any other biosafety cabinet customized for the needs of the particular application so long as the biosafety cabinet maintains a sterile work environment and laminar flow as described herein.

Still referring to FIG. 1, the biosafety cabinet 100 may generate and maintain a sterile work environment in the work area 106. In particular, the biosafety cabinet 100 may include an air filtration system (not depicted) which may sterilize the air within the work area 106. Specifically, the air filtration system may continuously filter the air within the work area 106 such that the environment is continuously cycled and sterilized and such that a laminar airflow within the work area 106 is provided. In embodiments, the biosafety cabinet 100 may include a high efficiency particulate air (“HEPA”) filter. The air filtration system may create a negative pressure at the opening 108 such that air from the work area 106 flows into the air filtration system of the biosafety cabinet 100 and does not exit the biosafety cabinet 100. As will be appreciated by those skilled in the art, the air from outside of the biosafety cabinet 100 that enters through the opening 108 may pass beneath the workstation 140 and upwards along a back wall 110 of the body 102 where the air is filtered and recirculated into the work area 106. The air from outside of the biosafety cabinet 100 may then enter the air filtration system.

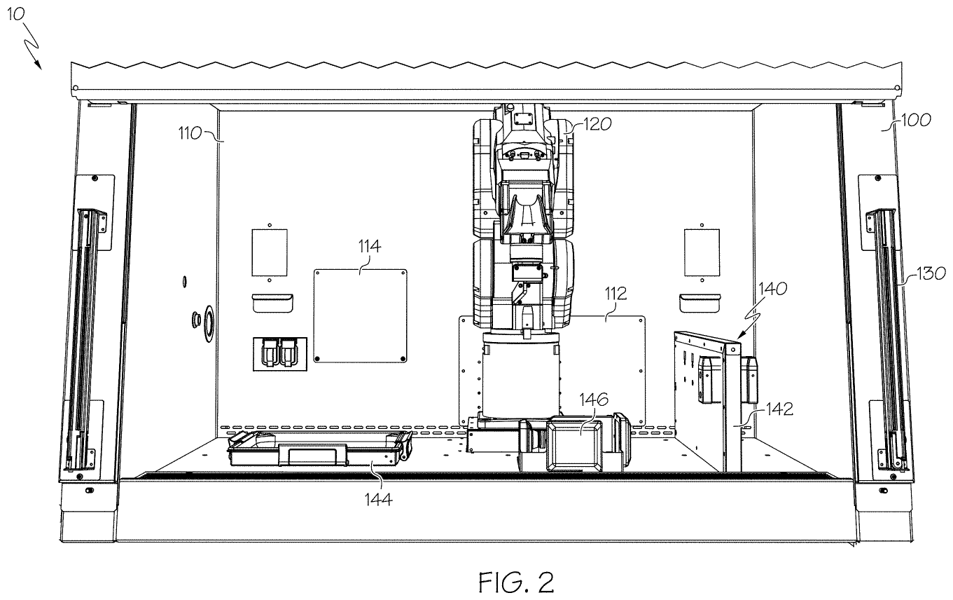

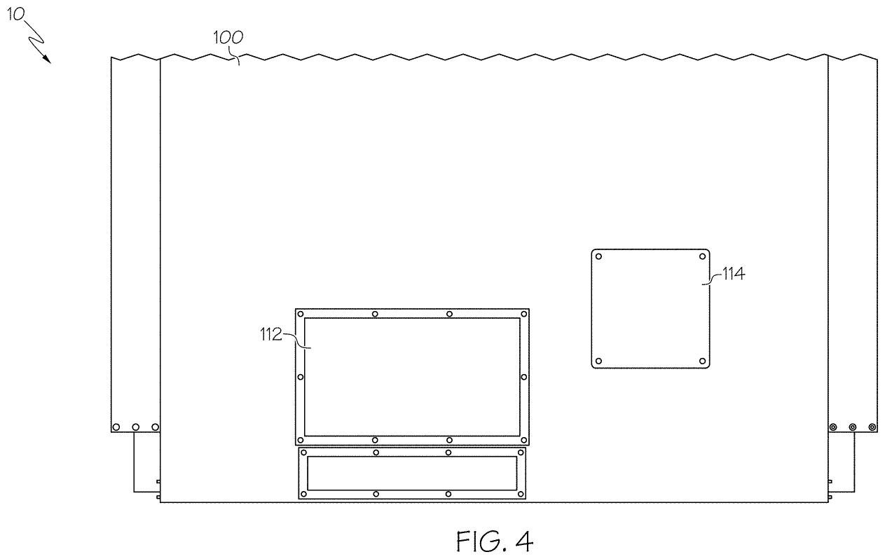

Referring to FIG. 2, a front view of the work area 106 of the biosafety cabinet 100 is schematically depicted. As depicted, the body 102 of the biosafety cabinet 100 may include a cabling panel 112 and an integration port 114. The cabling panel 112 and the integration port 114 may each be openings through the back wall 110 of the body 102. This can be seen particularly in FIG. 4, which schematically depicts a rear view of the back wall 110 of the biosafety cabinet 100. However, it is noted that, in other embodiments, the cabling panel 112 and the integration port 114 may each be openings through a side wall of the body 102. Referring back to FIG. 2, the cabling panel 112 may be an opening through which cables, tubing, or other components may be passed into the work area 106 while maintaining the sterile environment within the work area 106. In some embodiments, the cabling panel 112 may be sealed about any cables disposed therein such that the cabling panel 112 prevents contaminants from entering the work area 106. In some embodiments, the biosafety cabinet 100 may maintain a positive pressure at the cabling panel 112 such that air and/or contaminants from outside of the biosafety cabinet 100 may not pass into the work area 106.

The integration port 114 may also be an opening into the work area 106. As will be described in greater detail herein, the integration port 114 may enable transfer of work pieces (not depicted) into and out of the work area 106 while maintaining the sterile environment within the work area 106. The biosafety cabinet 100 may maintain a positive pressure at the integration port 114 such that air and/or contaminants from outside of the biosafety cabinet 100 may not enter the work area 106. Accordingly, by maintaining this positive pressure, the integration port 114 may remain open during use of the biosafety cabinet 100 without contaminating the work area 106, without allowing air from the work area 106 to exit the biosafety cabinet 100, and without sacrificing the laminar flow within the biosafety cabinet 100. In some embodiments, the integration port 114, may include a door configured to open and close the integration port 114. In some embodiments, such a door may be automated to open and close, for example by using a motion sensor.

Still referring to FIG. 2, the articulating arm 120 and the workstation 140 may be disposed within the work area 106. The articulating arm 120 may be a six axis articulating arm. In embodiments, the articulating arm 120 may be ceiling mounted within the biosafety cabinet 100. In other embodiments and, in particular, in embodiments in which the air filtration system is located in the ceiling of the biosafety cabinet 100, the articulating arm 120 may be floor mounted so as to not to disrupt the laminar airflow entering the air filtration system through the ceiling. The articulating arm 120 may be positioned within the work are 106 such that it may reach both the workstation 140 and the integration port 114. For example, as depicted, the integration port 114 is disposed to the left of the articulating arm 120 such that the articulating arm 120 may easily reach an item received through the integration port 114.

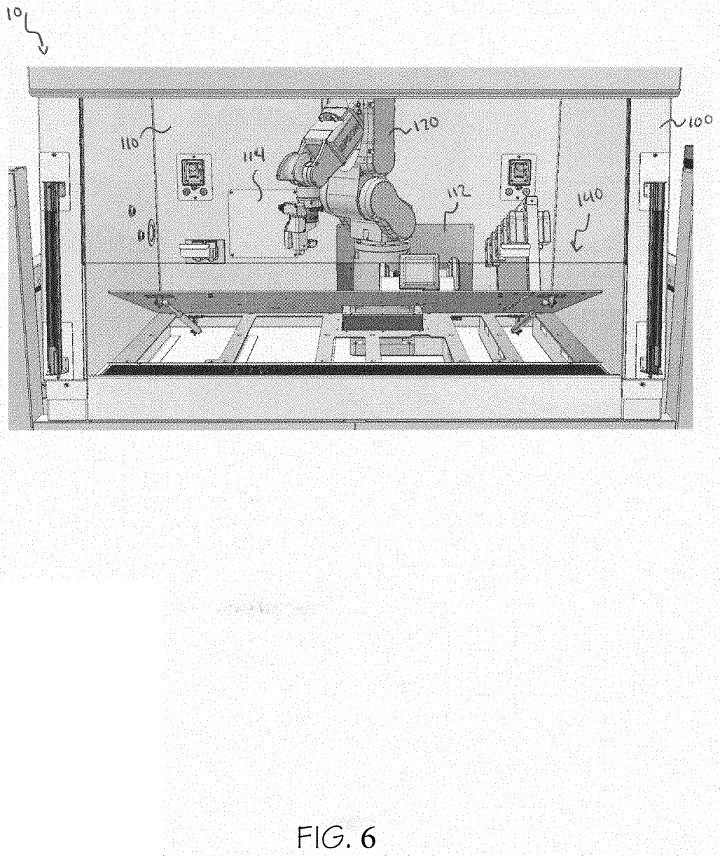

In embodiments, the workstation 140 may be configured for biofabrication. Accordingly, the workstation 140 may include a plurality of features, such as, for example, an end effector bay 142, a stage 144, which may be a printing stage or a tissue assembly stage, and a dispensing tip calibration system 146. The workstation 140 may include additional and/or alternative features other than those described. In some embodiments, the workstation 140 may be similar to the BioAssemblyBot 400 (BAB400, Advanced Solutions Life Sciences, Louisville, Ky.) platform (see, for example, U.S. Pat. Nos. 9,910,935 and 10,838,404, incorporated herein by reference in their entirety). In some embodiments, the workstation 140 may include sensors and other equipment for environmental sensing and logging of metrics such as air temperature, relative humidity, ambient pressure, and ambient CO₂ concentration. For example, the workstation 140 may include a temperature sensor configured and positioned to measure an air temperature within the work area 106. In some embodiments, and as depicted, for example, in FIG. 6, the workstation 140 may also be able to be lifted, tilted, or pivoted to allow for improved clean and sterile wipe-down during use. In particular, the workstation 140 may be coupled to the biosafety cabinet 100 such that the workstation 140 may be tilted upward.

Referring back to FIG. 1, the machine base 160 is configured to structurally support the overall weight of the platform 10 and the kinematic reaction forces and/or torques generated by movement of the articulating arm 120. In particular, the machine base 160 may have feet 164 coupled to legs 162, which may be sized and positioned to provide such structural support. The legs 162 may be adjustable to a variety of heights, which may provide ergonomic function and/or allow for easy transport through doors and entryways without requiring disassembly of the platform during site installation. In particular, the legs 162 may be adjustable to a shorter height than depicted in FIG. 1, such that wheels 166 coupled to the machine base 160 may contact the ground and allow for easier transport of the platform 10. In embodiments, the legs 162 may be manually adjustable or may be adjusted via powered actuation.

Still referring to FIG. 1, in some embodiments, the biosafety cabinet 100 may include safety light curtains 130. The safety light curtains 130 may be configured turn on and off and/or change color as a function of sensor feedback. For example, the safety light curtains 130 may turn on if an operator were to put a head, hand, or arm through the opening 108 and into the work area 106 while the robotic platform is running/moving. This may add an additional layer of safety protection.

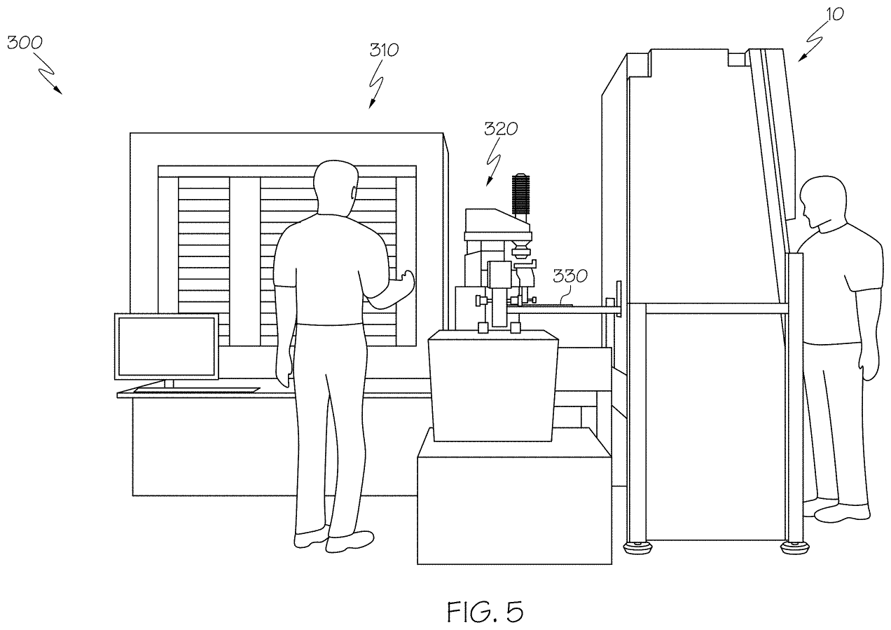

Referring now to FIG. 5, the platform 10 may be incorporated into a biofabrication system 300. The biofabrication system 300 may include the platform 10 and an articulating arm 320. Like the articulating arm 120, the articulating arm 320 may be a six axis articulating arm. The biofabrication system 300 may be configured such that the articulating arm 320 may pass an item (not depicted), such as a petri dish, tool, bioproduct or other item, into and/or out of the biosafety cabinet 100 of the platform 10. For example, as depicted, the biofabrication system 300 may include a conveyer 330 disposed between the articulating arm 320 and the integration port 114 of the biosafety cabinet 100. The conveyer 330 may be configured to transport an item positioned on the conveyer 330 along the length of the conveyer 330. In particular, in some embodiments, the conveyer 330 may extend into the integration port 114. The conveyer 330 may be extendable such that it temporarily extends into the integration port 114 or it may have a fixed length such that it permanently extends into the integration port 114. Accordingly, the articulating arm 320 may place an item onto the conveyer 330, which may transport the item through the integration port 114. Referring to FIGS. 2 and 5 in combination, the articulating arm 120 of the platform 10 may then pick up the item from the conveyer 330 and move it to the workstation 140 and within the work area 106 as needed. As will be appreciated, an item may be removed from the platform 10 in a similar manner. In this way, the biofabrication system 300 may transfer items to and from the platform 10 without introducing contaminants to the item or to the work area 106.

Still referring to FIG. 5, the biofabrication system 300 may include a second station 310. The second station 310 may be a machine, incubator, or other station that would be used in the biofabrication workflow. In embodiments, the articulating arm 320 may be configured to transfer items to and/or from the second station 310. Accordingly, as will now be appreciated, a method of using the biofabrication system 300 may include transferring an item between the platform 10 and the second station 310 in an automated manner such as described. In this way, the biofabrication system 300 may transfer items between the platform 10 and the second station 310 with minimal opportunity for contamination to the items or to the work area 106.

In view of the above, it should now be understood that at least some embodiments of the present disclosure are directed to a biofabrication system that includes a workstation and an articulating arm disposed within a work area of a biosafety cabinet. The workstation may include a stage, such as a printing stage or a tissue assembly stage, for biofabrication or, more specifically, bioprinting or assembly of a bioproduct. The biosafety cabinet may include an integration port that provides access to the work area through a wall of the biosafety cabinet. The articulating arm may be positioned to reach the workstation and the integration port. In this way, the articulating arm may receive or send out an item through the integration port and may move the item about the workstation without sacrificing the laminar flow or sterile environment of the biosafety cabinet. In some embodiments, the laminar flow and sterile environment may be maintained within the work area of the biosafety cabinet even when the integration port remains fully open.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A biofabrication system comprising:
a biosafety cabinet comprising an integration port that provides access to a work area within the biosafety cabinet through a wall of the biosafety cabinet;
a workstation disposed within the work area of the biosafety cabinet and comprising a stage configured for biofabrication; and
an articulating arm disposed within the work area of the biosafety cabinet and positioned to reach the workstation and the integration port.

2. The biofabrication system of claim 1, wherein the integration port is positioned at a back wall of the biosafety cabinet.

3. The biofabrication system of claim 1, wherein the biosafety cabinet maintains a positive pressure at the integration port such that air may pass out the biosafety cabinet through the integration port but is prevented from passing into the biosafety cabinet through the integration port.

4. The biofabrication system of claim 1, wherein:
the biosafety cabinet further comprises a cabling panel through a back wall of the biosafety cabinet.

5. The biofabrication system of claim 1 further comprising a conveyer positioned to extend into the biosafety cabinet through the integration port.

6. The biofabrication system of claim 1 further comprising a second articulating arm disposed outside of the biosafety cabinet and configured to pass an item into the biosafety cabinet via the integration port.

7. The biofabrication system of claim 6, further comprising a second station, wherein the second articulating arm is configured to pass the item from the second station and into the biosafety cabinet via the integration port.

8. The biofabrication system of claim 1, wherein the biosafety cabinet comprises a sash and defines an opening into the biosafety cabinet beneath the sash.

9. The biofabrication system of claim 1, wherein the workstation is coupled to the biosafety cabinet such that the workstation may be tilted upward.

10. The biofabrication system of claim 1, wherein the biosafety cabinet is supported by legs having adjustable height.

11. The biofabrication system of claim 1, wherein the workstation comprises an end effector bay.

12. The biofabrication system of claim 1, wherein the workstation comprises a temperature sensor configured and positioned to measure an air temperature within the work area.

13. A method of biofabrication comprising:
printing a bioproduct on a stage of a biofabrication system, the biofabrication system comprising:
a biosafety cabinet comprising an integration port that provides access to a work area within the biosafety cabinet through a wall of the biosafety cabinet;
a workstation disposed within the work area of the biosafety cabinet and comprising the stage; and
an articulating arm disposed within the work area of the biosafety cabinet and positioned to reach the workstation and the integration port.

14. The method of claim 13, further comprising maintaining a positive pressure at the integration port such that air may pass out the biosafety cabinet through the integration port but is prevented from passing into the biosafety cabinet through the integration port.

15. The method of claim 13, further comprising:
transferring the bioproduct out of the biosafety cabinet using the articulating arm.

16. The method of claim 15, wherein the transferring the bioproduct includes positioning the bioproduct on a conveyer using the articulating arm, wherein the conveyer extends through the integration port.

17. The method of claim 16, further comprising, transferring the bioproduct to a second station using a second articulating arm.

18. A method of biofabrication comprising:
receiving an item through an integration port of a biofabrication system, the biofabrication system comprising:
a biosafety cabinet comprising the integration port, wherein the integration port provides access to a work area within the biosafety cabinet through a wall of the biosafety cabinet;
a workstation disposed within the work area of the biosafety cabinet and comprising a stage configured for biofabrication; and
an articulating arm disposed within the work area of the biosafety cabinet and positioned to reach the workstation and the integration port; and
moving the item from the integration port to the workstation with the articulating arm.

19. The method of claim 18, further comprising maintaining a positive pressure at the integration port such that air may pass out the biosafety cabinet through the integration port but is prevented from passing into the biosafety cabinet through the integration port.

20. The method of claim 18, wherein the receiving the item through the integration port comprises transporting the item on a conveyer extending through the integration port.
